(19) United States
(12) Patent Application Publication
(10) Pub. No.: US 2015/0262549 A1
(43) Pub. Date: Sep. 17, 2015

(54) Color Palette Generation

(71) Applicant: HEWLETT-PACKARD DEVELOPMENT COMPANY, L.P., Houston, TX (US)

(72) Inventor: Nathan Moroney, Palo Alto, CA (US)

(21) Appl. No.: 14/439,287

(22) PCT Filed: Oct. 31, 2012
(86) PCT No.: PCT/US2012/062803

§ 371 Date: Apr. 29, 2015

(51) Int. Cl. G09G 5/06; G06T 7/40; G06T 7/00; G06T 11/00

(52) U.S. Cl. CPC G09G 5/06; G06T 11/001; G06T 7/408; G06T 7/0081; G06T 2211/416; G06T 2207/10024; G06T 2207/10004; G06T 2207/20144; G09G 2320/0666

(57) ABSTRACT

A method of extracting a color palette includes receiving in color attribute values of corresponding a image elements representing an image, transforming initial color attribute values to lexical color classifiers of the corresponding image elements, clustering the image dements based on the lexical color classifiers into clusters of image elements, and generating a color palette having color regions, each color region corresponding to a color associated with a cluster of image elements.

### BACKGROUND

Colors often present themselves in a complex manner image or item. For example, textile fabrics have some degree of spatial color. Color information from an image as is photographed, scanned, displayed or printed often contains a large number of discreet colors. For example, a portion of an image can contain hundreds of shades of distinctly different colors.

### BRIEF DESCRIPTION OF THE DRAWINGS

FIG. 1 is an example system for generating a color palette from an image.

FIG. 2 is a flow chart illustrating an example method for generating a color palette.

FIGS. 3A through 3E illustrate an example method of clustering image elements.

FIG. 4 is a block diagram of an example system.

FIG. 5 is a block diagram of an example system.

FIG. 6 is a block diagram of an example system.

FIG. 7 is a flow chart illustrating an example method for generating a color palette.

FIG. 8 is a flow chart illustrating an example method for generating a color palette.

### DETAILED DESCRIPTION

In the following detailed description, reference is made to the accompanying drawings which form a part hereof, and in which is shown by of illustration specific examples in which he: invention may be practiced. In this regard, directional terminology, such as “top”, “bottom,” “front,” “back,” “leading,” “trailing,” etc., is used with reference to the orientation of the Figure(s) being described. Because components of examples can be positioned in a number of different orientations, the directional terminology is used for purposes of illustration and is in no way limiting. It is to be understood that other examples may be utilized and structural or logical changes may be made without departing from the scope of the present invention. The following detailed description, therefore, is not to be taken in a limiting sense, and the scope of the present invention is defined by the appended claims. It is to be understood that features of the various examples described herein may be combined with each other, unless specifically noted otherwise.

For purposes of design, visualization, searching and organization, it is helpful to reduce a large number of colors of a complex color image or item to a much smaller number of visually distinct and representative colors. Systems for selecting the different colors or shades in an image or item are often completed manually. Creating a simplified color palette from complex color input is typically a highly time consuming and largely subjective process. Generally an expert user, such as a designer or artist, will use academic training, professional experience, personal perception, and personal preference to create a color palette from a complex color input. Accordingly, use of an expert does not typically provide consistent results and lacks systematic and repeatable sets of color palettes across experts.

Examples provide systems and methods of extracting a color palette from an image. An image can be based on two-dimensional or three-dimensional objects. Images often have multiple colors and can include some degree of spatial color, thereby having complex color input. Extraction of representative color palettes from complex color images can be useful for design, content creation, visualization, and indexing. Color measurement and color reproduction is used in commercial printing, for example. Commercial print automation, such as that used in printing commercial publications, direct mailings, and catalogs, use color matching for color reproduction.

Examples allow for color measurement and image capture on an input device and further decomposition of all or a portion of an image in calibration of colors. In one example, the input device is a mobile device, such as a mobile smart phone, tablet, or other input device capable of capturing an image. The input device can be calibrated or not calibrated prior to the input of the image.

Alternatively, the image can have some degree of calibration. The image can be a whole image or a corrected image. In the context of accurate mobile color measurement, in one example, the image has been preprocessed to be color correct.

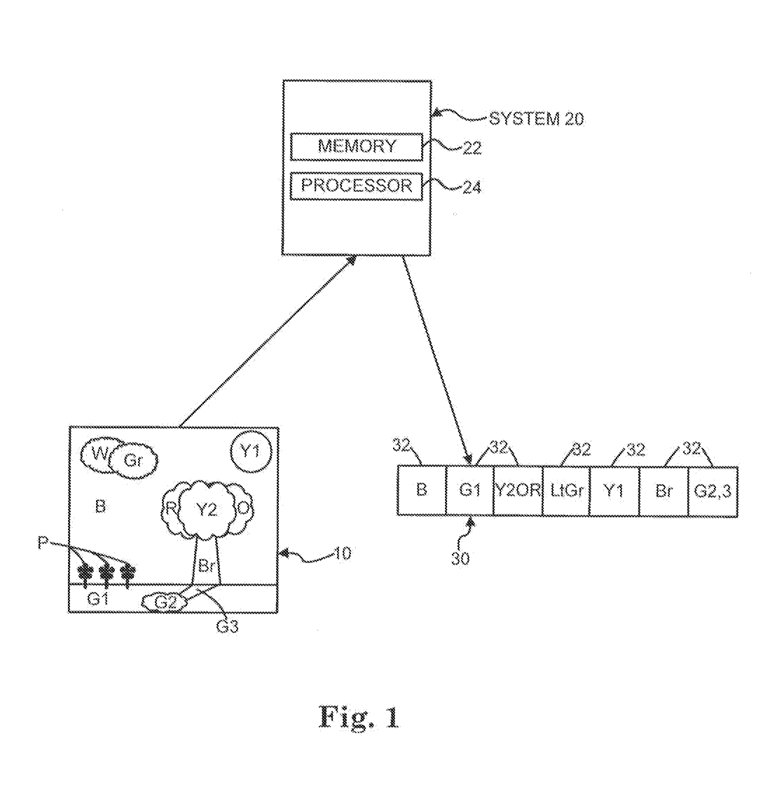

An example of a system 20 for generating a color palette 30 from an image 10 is illustrated in FIG. 1. Examples of image 10 include a scan, a video, a computer generated image, a printed image, a graphic, or a directory listing. Image 10 can be an image which includes several different colors. For example, image 10 can include various greens (G1, G2, and G3), brown (Br), blue (B), white (W), grey (Gr), various yellows (Y1, Y2), orange (O), red (R), and purple (P). In order to create color palette 30 from a complex image such as image 10, initial color attribute values of corresponding image elements (e.g., pixels or vector elements) representing image 10 are received by system 20. A memory 22 of system 20 stores the initial color attribute values and processor 24 of system 20 processes the initial color attribute values as discussed in greater detail below. Processor 24 is employed to generate, color palette 30 having an integer number N color regions 32. As herein defined, a color region is a region which has a representative color associated with it. The color palette can be displayed where the color regions are distinct stripes or sections of each color in the color palette. Alternatively or additionally, the color regions in the color palette can be displayed to include color names.

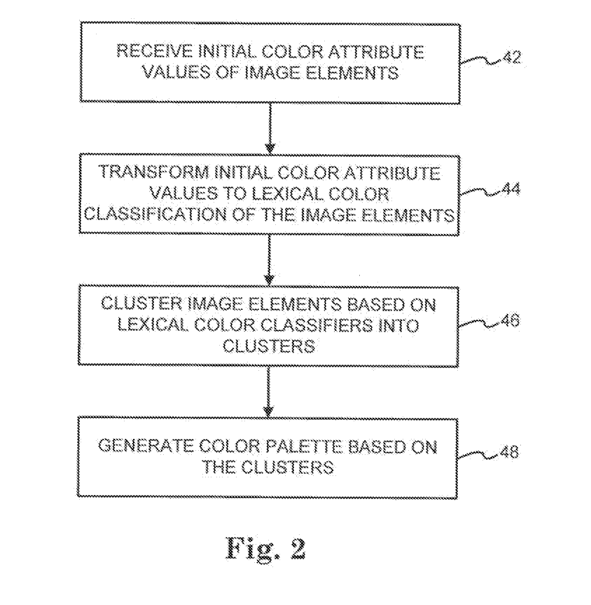

FIG. 2 illustrates an example of a method of extracting a color palette. At 42, initial color attribute values of corresponding image elements representing an image are received. At 44, the initial color attribute values are transformed to lexical color classifiers of corresponding image elements. These lexical color classifiers, or color names, are based on a given color vocabulary. In one example, accurate color naming and identification of the lexical color classifiers based on the initial color attribute values is a machine color naming process which is then applied for the segmentation and automatic decomposition of the initial color attribute values. Additionally, through color lexical classification, unknown colors find a closest or nearest color match. in one example, there are more initial color attribute values than there are lexical color classifiers. The lexical quantization or classification can result in a reduction of the total number of input colors from (e.g., 256 or more) unique red green-blue (RGB) values to an order of magnitude fewer (e.g. dozens) of color names. In one example, there are M possible lexical color classifiers and more than M possible color attribute values, where M is an integer number. In one example, the lexical color classifiers are fixed with respect to number and/or inclusion of specific lexical color classifiers. Alternatively, lexical color classifiers can be dynamically varying. Dynamic lexical color classifiers can provide for a larger or smaller number of lexical color classifiers to be used, allowing for a more or less detailed color palette. With dynamic lexical color classifiers, user specified color names can be included, such as “sky” or “teal”, for example. Including user specified color names would allow a user preferred color to be added to the color palette. Alternatively, specific color names could be excluded, thereby allowing colors that are not desired to be removed or excluded from the color palette.

At 46, the image elements are clustered based on the. lexical color classifiers into N clusters. N is an integer number. In one example, N is less than M. In one example, clustering includes weighting the lexical color classifiers via associated color attribute value locations within the image. In one example, clustering includes weighting the lexical color classifiers via associated size within or overall area occupied by the image. At 48, a color palette having N color regions is generated based on the clustered image elements. In one example, each of the N color regions is represented by a single lexical color classifier, in one example, weighting by location, area, or size provides a prioritization of the color names and resulting colors in the color palette.

In one example, the clustering method is operated to place mean values in a way that the mean values are more heavily weighted and have a very stable sort of boundaries between the clusters in order to achieve a set of colors that is most representative. Color saliency (i.e., how reliably a color is named) axed coir name distance, the similarity between colors based on naming patterns) are both used to create a histogram of colors and associated lexical classifications. Lexical color conversion or transformation from numeric color encodings, such as RGB triplets, to color terms yields en intuitive, consistent and cognitively encoded or categorical initial data reduction scheme. A weighting schemes by location and size allow some degree of user control of the palette creation process in as much as users can specify higher weight for certain portions of the input, for example, the center of an image versus the edges or higher weights for color regions of a given size, such as weighting smaller color regions versus larger color regions. The clustering processes can provide a further level of automation to reach the color palette. The weighting and clustering can be configured to fixed, predetermined values.

Alternatively, various applicable methods can be used. Clustering the lexical color classifiers involves application of a technique as further discussed below. For example, K-harmonic means can be used. Supervised unsupervised clustering can be applied to generate a given color palette. Supervised clustering, for example K-harmonic clustering, can be used to achieve a color palette of variable size.

Data clustering is one common technique used in data mining. A popular performance function for measuring goodness of data clustering is the total within-cluster variance, or the total mean-square quantization error (MSE). The K means technique is a popular method which attempts to find K clustering which minimizes MSE. The K means technique is a center based clustering method. The dependency of the K means performance on the initialization of the centers can be a major issue; a similar issue exists for alternative technique expectation maximization (EM), of or to a lesser extent. K-harmonic means technique (KHM) is a center based clustering method which uses the harmonic averages of the distances from each data point to the centers as components to its performance function.

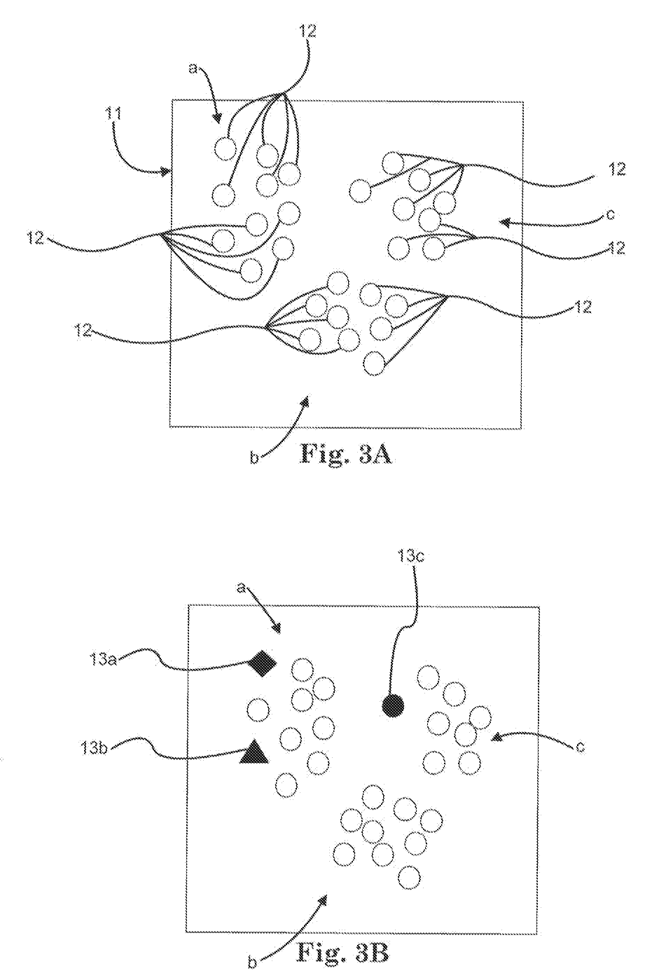

FIGS. 3A through 3E illustrate an example method of clustering image elements based on lexical color classifiers. FIG. 3A illustrates a 2D histogram 11 including multiple image elements 12 wherein each image element has a corresponding lexical color classifier with a corresponding color frequency. In FIG. 3A, the image elements 12 are arranged in spatial proximity mapping to an approximate shade of color (i.e., color frequency) in initial color clusters a, b, and c having image elements with estimated similar spatial proximity and color frequency. As illustrated in FIG. 3B, a number of K-cluster centers (i.e., duster centroids 13) are pseudo-randomly selected as an example image element of each of the clusters a, b, and c. Cluster centroid 13a is an example image element of cluster a; cluster centroid 13b an example image element of cluster o; cluster centroid 13c is an example image element of cluster c. FIG. 3C illustrates image elements 12 assigned to the estimated nearest, in a color frequency and spatial relationship, cluster centroid 13 to form dusters 14a, 14b, and 14c. As indicated by arrow 15 in FIG. 30, each of the cluster centroids 13a, 13b, and 13c is realigned within the respective duster 14a, 14b, and 14c. Accordingly, as illustrated in FIG. 30, realigned cluster centroids 16a, 16b, and 16c are produced. As illustrated in FIG. 3E, revised clusters 17a, 17b, and 17c are generated based on the realigned cluster centroids 16a, 16b, and 16c and the image elements 12 are reassigned to the revised clusters 17. These steps can be repeated until an exit condition, such as a set number of iterations or threshold for change in cluster centroids, is achieved to provide k-harmonic means convergence of the image elements based on the image element's corresponding color frequencies (i.e., lexical color classifiers) and spatial relationships.

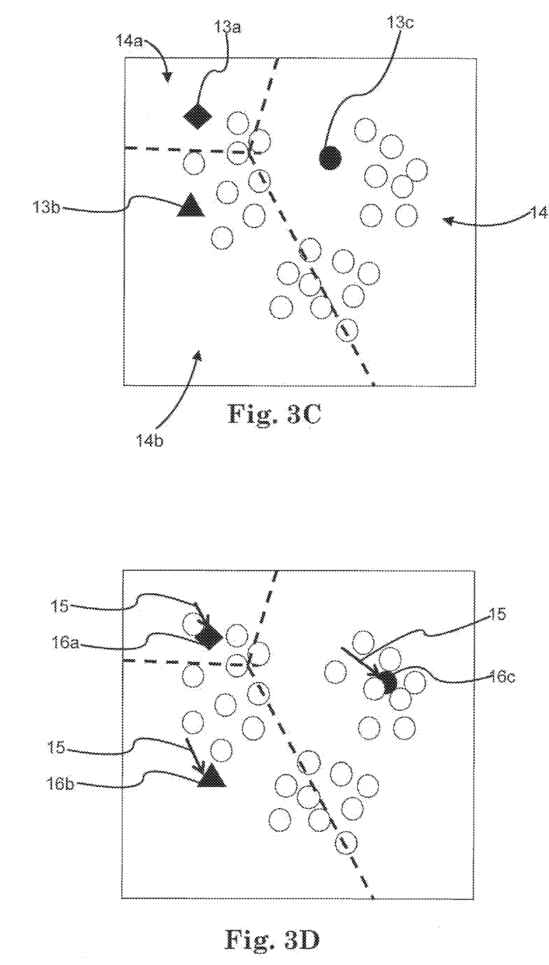

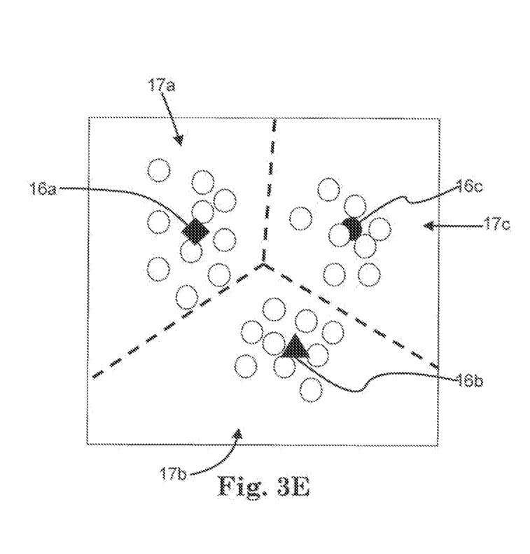

FIGS. 4 through 6 illustrate block diagrams of examples of systems employed to extract a color palette from an image. Systems 50, 60, 70 can be employed to receive complex color input including spatially bearing colored input including hundreds, thousands, or even millions of colors and generate a color palette including an order of magnitude fewer colors (e.g., on the order of five to ten colors).

An input device 52, 62, 72 of system 50, 60, 70, respectively, captures the initial color attribute values of corresponding image elements representing the image, In one example, the image is a raster image and the image elements are pixels. In one example, the image is a vector image and the image. elements are vector elements. Input device 52, 72 can be included in the system, as illustrated with systems 50 and 70. Alternatively, input device 62 can be external to the system, as illustrated with system 60. Input device 52, 62 can be a mobile device, such as a mobile smart phone or tablet, for example, or other input device capable of capturing an image.

The initial color attribute values can be captured in the form of a conventional color encoding, such as red-green-blue (RGB) pixel value, an three-dimensional (XYZ) measurement, or a Commission international de l'éclairage Lightness and color-opponent dimension A and B (CIELAB) encoding. With additional reference to FIG. 1, initial color attribute values of corresponding image elements representing the image are received and saved in memory 22, 54, 64, 74 of system 20, 50, 60, 70, respectively. Memory 22, 54, 64, 74 also stores instructions.

Processor 24, 56, 66, executes the instructions stored in memory 22, 54, 64, 74, respectively. Processor 56, SS, 76 references a database 58, 68, 69, 78, respectively, which includes a set of lexical classifiers corresponding to particular color attribute values. Processor 24, 56, 66, 76 transforms the initial color attribute values to lexical color classifiers of the corresponding image elements. For example, with a raster image, each pixel is associated with one lexical color classifier. In one example, processor 24, 56, 66, 76 employs a transformational quantizational technique to transform the initial color attribute values to the lexical color classifiers, (i.e., the assigned color name).

After transforming the initial color attribute values to lexical color classifiers of the corresponding image elements, processor 24, 56, 76 clusters the image elements based on the lexical color classifiers into clusters of image elements. Processor 56, 66, 76 generates a color palette having color regions, each color region formed from an associated cluster of image elements. For example there can be seven color regions in the color palette with each color region being represented by one lexical color classifier, in one example, the lexical color classifiers are weighted by size within each region of interest for example, or by location within the image. The number of colors and/or color regions included on the color palette can be less than the number of lexical color classifiers.

In one example, a color naming system is scaled to assign lexical color classifiers from a large number of names or a small number of names, depending on the intended image application. A database of sufficient size is employed to permit such scalability. A scaling component can be used to specify a subset of the set of lexical color classifiers from which lexical color classifiers can be assigned for a given image. The scaling component can operate algorithmically, that is, by adding the names in terms of relative frequency of use or by using less commonly used names later. For instance, the number of color names can be set at 11 to limit the range of lexical classifiers which can be assigned to 11 commonly used basic color names (e.g., red, green, yellow, blue, brown, pink, orange, purple, white, gray, and black). The scaling component can also operate m accordance with user specified directions; for example, if the user wants to use a specific name.

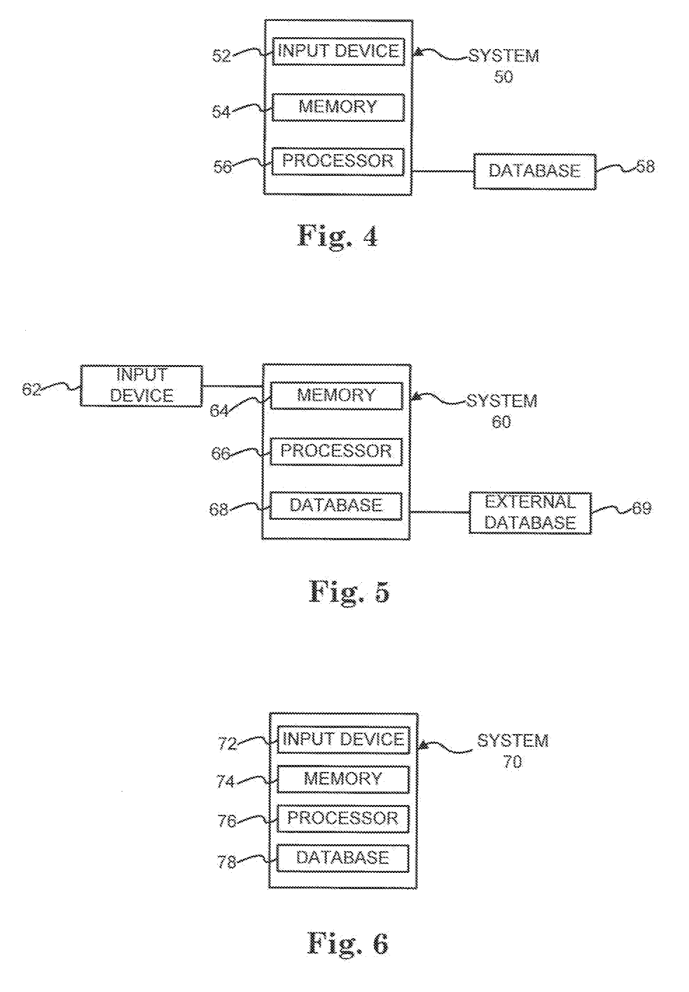

The lexical color classifiers are stored in database 58, 68, 69, 78. As illustrated in FIG. 6, database 78 can be within system 70 itself, or as illustrated in FIG. 4, database 58 is simply accessible to system 50 via internet or other communication mechanism. Alternatively, system 60 includes database 68 stored within system 80, as well as external database 69 which is accessible to system 60. In one example, database 68 includes a set of lexical color classifiers which is smaller than the set of lexical color classifiers stored in external database 69. External database 58, 69 can store a very large number of lexical color classifiers. Additional databases can also be used.

Databases 58, 68, 69, 78 include a collection of lexical color classifiers, The lexical color classifiers include a range of color names and can be a raw database of colors identified by people typing color names into the internet or can be a digested or cleaned pre-processed database which filters out spelling mistakes, obvious duplicates, and synonyms. Additionally, database 58, 68, 78 can include a targeted vocabulary of predefined terms associated with select color attributes. For example, the lexical color classifiers can include 11, 25 or other suitable number of preselected color names. In one example, with 25 preselected color names, 11 lexical color classifiers of commonly used color names are employed along with additional lexical classifiers (e.g., dark green and light green) which fill in between and/or are variations of the 11 common lexical color classifiers. The targeted vocabulary of predefined terms allows the creation of the color palette in a reasonable amount of time due to the predefined vocabulary being lamented. The reduction in the lexical classifiers for the predefined vocabulary allows for a quantization into a smaller number of color classifiers to be associated with the initial color attribute values. The select number of lexical color classifiers can be predetermined or can be variable.

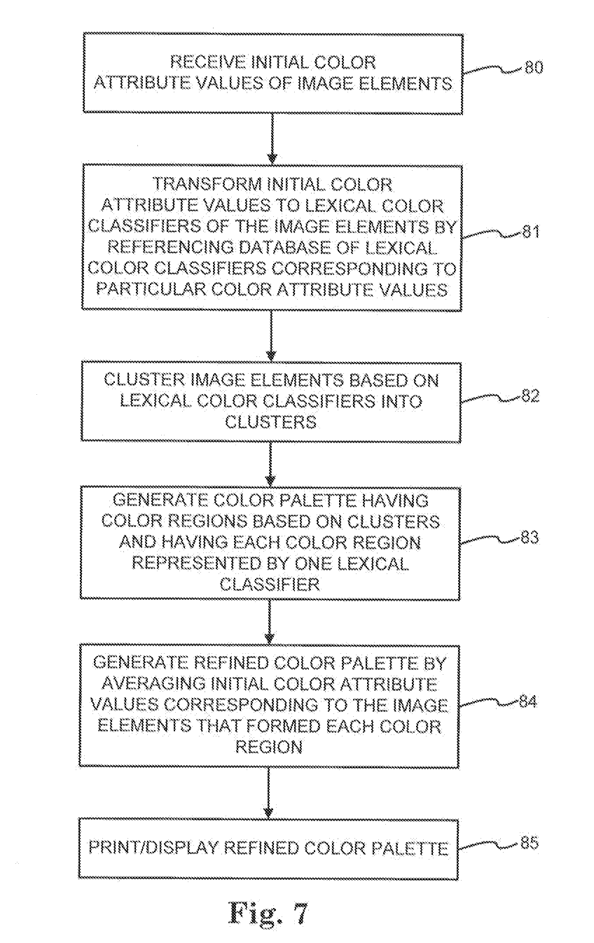

FIG. 7 illustrates an example method for generating a color palette. At 80, initial color attribute values of image elements are received. At 81, initial color attribute values are transformed to lexical color classifiers of the image elements by referencing the database of lexical color classifiers corresponding to particular color attribute values. At 82, image elements are clustered based on lexical color classifiers into clusters. At 83, a color palette is generated based on clusters and having each color region represented by one lexical classifier. At 84, a refined color palette is generated by averaging initial color attribute values corresponding to the image elements that formed each to region. At 85, the refined color palette is displayed and/or printed.

In one example, in order to capture the subtle nuance of the exact colors of the image and create the refined color palette, the clustered image elements in each color region of the first color palette are compared back to the original image and the initial color attribute values of image elements. The clustered image element can contain a range of original lexical color classifiers based on the initial color attribute values. Comparison to the initial color attribute values of the image elements provides the ability to get the color palette very close to the representative colors of the original image. In one example, the refined color palette is generated by averaging, for each of the color regions, the initial color attribute values corresponding to the image elements that formed the given color region to represent the given color region with an averaged color attribute value.

In one example, each of the colors of the color palette is for a color region formed from associated clusters of image elements, such that each of the color regions is represented by image elements (e.g., pixel or vector elements) which actually produce a specific lexical color classifier. This process allows for segmentation, data reduction, and clustering in order to produce the color palette. Once the dusters are generated, the actual source data of color attribute values corresponding to the image elements in a given color region are employed to produce the refined color palette. The color regions of a refined color palette are extracted from the original color attribute values, not the quantized values, to provide for subtle nuances of the exact colors of the image.

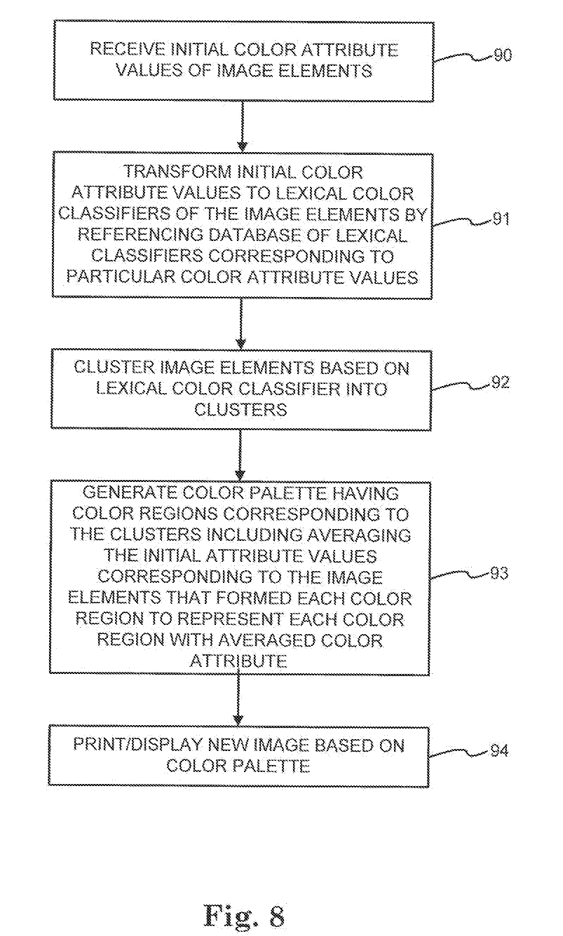

FIG. 8 illustrates an example method for generating a color palette. At 90, initial color attribute values of image elements are received. At 91, initial color attribute values are transformed to lexical color classifiers of the image elements by referencing the database of lexical color classifiers corresponding to particular color attribute values. At 92, image elements are clustered based on lexical color classifiers into clusters. At 93, a color palette having color regions corresponding to the clusters is generated including averaging the initial attribute values corresponding to the image elements that formed each color region to represent each color region with an averaged color attribute. At 94, a new image is displayed and/or printed based on the generated color palette. In one example, a second image is automatically displayed using two or more color regions from the color palette.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

1. A method of extracting a color palette comprising:
receiving initial color attribute values of corresponding image elements representing an image;
transforming the initial color attribute values to lexical color classifiers of the corresponding image elements;
clustering the image elements based on ale lexical color classifiers into dusters of image elements; and
generating a color palette having color regions, each color region having a color associated with a cluster of image elements.

2. The method of claim 1, wherein the color of each color region is represented by one lexical color classifier.

3. The method of claim 2, comprising:
generating a refined color palette having refined color regions, each refined color region having a refined color based on the initial color attribute values corresponding to the image elements of the associated cluster.

4. The method of claim 1, wherein the generating of the color palette comprises:
for each of the color regions generating the color based on the initial color attribute values corresponding to the image elements of the associated cluster.

5. The method of claim 1, comprising:
automatically displaying a second image using at least two colors of the color regions.

6. The method of claim 5, comprising:
dynamically varying the number of lexical color classifiers.

7. The method of claim 1, wherein transforming comprises:
reference to a database of lexical color classifiers corresponding to particular color attribute values.

8. The method of claim 1, wherein clustering comprises:
weighting the lexical color classifiers via one of associated color attribute value locations within the image and associated size within the image.

9. A system, comprising:
a memory to store instructions and initial color attribute values;
a processor to execute the instructions in the memory to:
reference a database having a set of lexical classifiers corresponding to particular color attribute values;
transform the initial color attribute values to lexical color classifiers of the corresponding image elements;
cluster the image elements based on the lexical color classifiers into clusters of image elements, and
generate a color palette having color regions, each color region having a color based on an associated cluster of image elements.

10. The system of claim 9, wherein the system includes the database.

11. The system of claim 9, wherein the database references an external database that includes more possible lexical color classifiers.

12. The system of claim 9, wherein the database is external to the system.

13. The system of claim 9, comprising:
an input device configured to capture the initial color attribute values of the corresponding image elements representing an image.

14. A computer-readable storage medium storing computer executable instructions for controlling a computer to perform a method comprising:
receiving initial color attribute values of corresponding image elements representing an image;
transforming the initial color attribute values to lexical color classifiers of corresponding image elements;
clustering the image elements based on the lexical classifiers into clusters of image elements; and
generating a color palette having color regions having a color based on the clustered image elements.

15. The compute-readable storage medium of claim 14, wherein the image is one of a raster image with the image elements being pixels and a vector image with the image elements being vector elements.
